(19) United States
(12) Patent Application Publication
(10) Pub. No.: US 2023/0022010 A1
(43) Pub. Date: Jan. 26, 2023

(54) DYNAMIC RECEIPT METHOD IN AN AUTONOMOUS STORE

(71) Applicant: AiFi Corp, Santa Clara, CA (US)

(72) Inventors: Joao Falcao, Santa Clara, CA (US); Bartosz Michalak, Santa Clara, CA (US); Henrique Fernandes, Santa Clara, CA (US); Frank Jensen, Santa Clara, CA (US); Kendall Clifton d Weisel, Santa Clara, CA (US)

(73) Assignee: AiFi Corp, Santa Clara, CA (US)

(21) Appl. No.: 17/382,357

(22) Filed: Jul. 22, 2021

(51) Int. Cl. G06Q 30/06; G06Q 20/20; G06K 9/00; G06Q 30/02; G06Q 20/32

(52) U.S. Cl. CPC G06Q 30/0641; G06K 9/00771; G06Q 20/209; G06Q 20/326; G06Q 30/0261; G06Q 30/0633

(57) ABSTRACT

This application relates to systems, methods, devices, and other techniques for dynamic and real-time updated receipts in an autonomous store

### BACKGROUND OF THE INVENTION

This application relates to systems, methods, devices, and other techniques for dynamic and real-time updated receipts in an autonomous store.

Methods and apparatus for receipts in a retail store for monitoring products and customers are well known and in practices. However, systems, methods, devices, and other techniques for dynamic and real-time updated receipts for a smart autonomous store that can be utilized within a retail environment need is new and could be combined with recently developed AI and machine learning and sensor technology.

Therefore, it is desirable to have systems, methods, devices, and other techniques for a dynamic and real-time updated receipt in an autonomous store.

### SUMMARY OF THE INVENTION

This application relates to systems, methods, devices, and other techniques for dynamic and real-time updated receipts in an autonomous store.

In some embodiments, the invention is related to a method of tracking items picked by a user in an autonomous retail store.

In some embodiments, the method comprises a step of receiving, by a mobile device held by the user via a communications network from a server, a digital token linked to the user upon the user’s entry into the autonomous retail store, wherein the user does not need to input any information to the server.

In some embodiments, the method comprises a step of tracking the user and the items picked by the user in real-time, by a camera system coupled to the server within the autonomous retail store.

In some embodiments, the method comprises a step of relating information of the items picked by the user to the digital token.

In some embodiments, the method comprises a step of recording and forwarding the information of the items picked by the user in real-time to the server.

In some embodiments, the method comprises a step of displaying the information of the items picked by the user in real-time and other information to the user when the user selects to view the information of the items by clicking the digital token, wherein the digital token is stored in a mobile application.

In some embodiments, the method comprises a step of updating the information of the items picked by the user to the digital token when the user continues to shop in the autonomous retail store.

In some embodiments, the method comprises a step of generating a receipt based on the information of the items checked out by the user after the user exits the autonomous retail store, wherein the receipt comprises items checked out by the user, price of any of the items checked out by the user, and regulatory required information.

In some embodiments, the method comprises a step of displaying the information of the items checked out by the user when the user selects to view the information of the items checked out by the user by clicking the digital token.

In some embodiments, the other information comprises advertisement and promotion of products in the autonomous retail store.

In some embodiments, the invention is related to another method of tracking items picked by a user in an autonomous retail store.

In some embodiments, the method comprises a step of receiving, by a mobile device’s camera, a digital token linked to the user upon the user’s entry into the autonomous retail store, wherein the user does not need to input any information to the server.

In some embodiments, the method comprises a step of tracking the user and the items picked by the user in real-time, by a camera system coupled to the server within the autonomous retail store.

In some embodiments, the method comprises a step of relating information of the items picked by the user to the digital token.

In some embodiments, the method comprises a step of recording and forwarding the information of the items picked by the user in real-time to the server.

In some embodiments, the method comprises a step of displaying the information of the items picked by the user in real-time and other information to the user when the user selects to view the information of the items by clicking the digital token, wherein the digital token is stored in a mobile application.

In some embodiments, the method comprises a step of updating the information of the items picked by the user to the digital token when the user continues to shop in the autonomous retail store.

In some embodiments, the method comprises a step of generating a receipt based on the information of the items checked out by the user after the user exits the autonomous retail store, wherein the receipt comprises items checked out by the user, price of any of the items checked out by the user, and regulatory required information.

In some embodiments, the method comprises a step of displaying the information of the items checked out by the user when the user selects to view the information of the items checked out by the user by clicking the digital token.

In some embodiments, the other information comprises advertisement and promotion of products in the autonomous retail store.

In some embodiments, the invention is related to a third method of tracking items picked by a user in an autonomous retail store.

In some embodiments, the method comprises a step of printing out a 2D code on a piece of paper from a printer linked to a server, wherein the 2D code is presented to the user, wherein the 2D code is linked to a digital token, wherein the digital token is linked to the user upon the user’s entry into the autonomous retail store, wherein the user does not need to input any information to the server.

In some embodiments, the method comprises a step of tracking the user and the items picked by the user in real-time, by a camera system coupled to the server within the autonomous retail store.

In some embodiments, the method comprises a step of relating information of the items picked by the user to the digital token.

In some embodiments, the method comprises a step of recording and forwarding the information of the items picked by the user in real-time to the server.

In some embodiments, the method comprises a step of displaying the information of the items picked by the user in real-time and other information to the user on a mobile device when the user selects to view the information of the items by scanning the 2D code on the mobile device and triggering an application on the mobile device.

In some embodiments, the method comprises a step of updating the information of the items picked by the user to the digital token when the user continues to shop in the autonomous retail store.

In some embodiments, the method comprises a step of generating a receipt linked to the digital token and the 2D code, based on the information of the items picked and checked out by the user after the user exits the autonomous retail store, wherein the receipt comprises items checked out by the user, price of any of the items checked out by the user, and regulatory required information.

In some embodiments, the method comprises a step of displaying the information of the items checked out by the user when the user selects to view the information of the items checked out by the user by scanning the 2D code on the mobile device and triggering an application on the mobile device.

In some embodiments, the other information comprises advertisement and promotion of products in the autonomous retail store.

These and other aspects, their implementations and other features are described in details in the drawings, the description and the claims.

### BRIEF DESCRIPTION OF THE DRAWINGS

FIG. 1 shows an example of a method of tracking items picked by a user in an autonomous retail store.

FIG. 2 shows another example of another method of tracking items picked by a user in an autonomous retail store.

FIG. 3 shows a third example of a third method of tracking items picked by a user in an autonomous retail store.

### DETAILED DESCRIPTION OF THE INVENTION

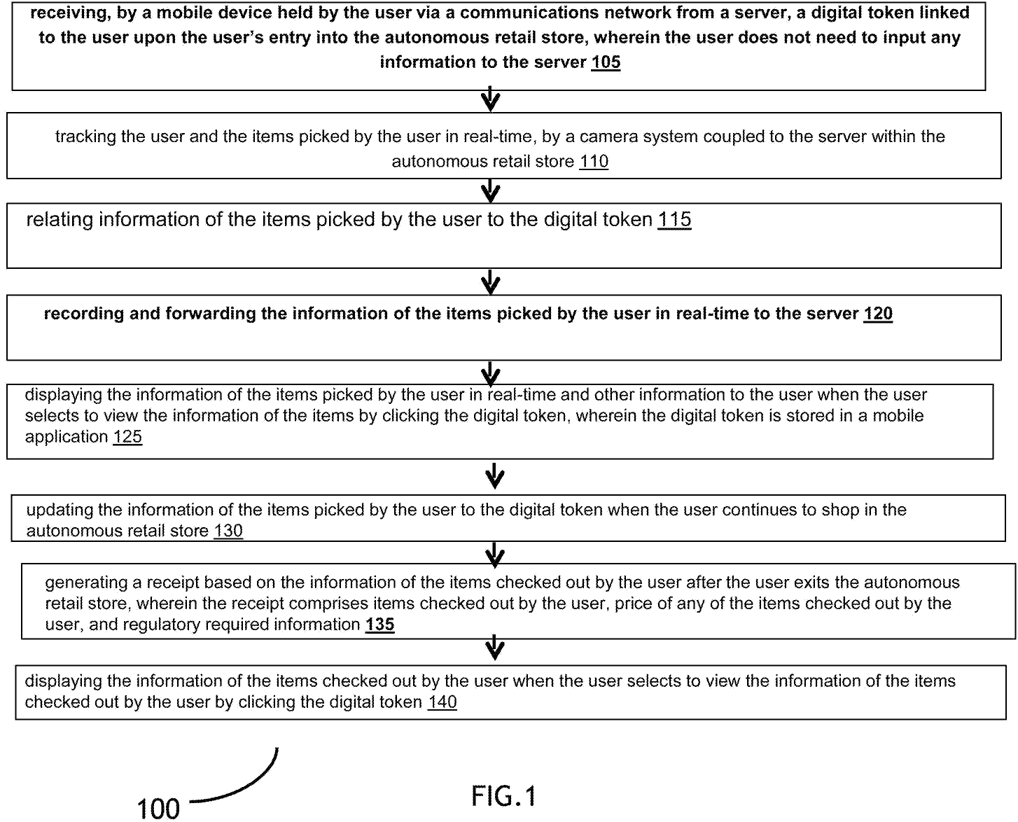

FIG. 1 shows an example of a method 100 of tracking items picked by a user in an autonomous retail store.

In some embodiments, the method comprises a step 105 of receiving, by a mobile device held by the user via a communications network from a server, a digital token linked to the user upon the user’s entry into the autonomous retail store, wherein the user does not need to input any information to the server.

In some embodiments, the method comprises a step 110 of tracking the user and the items picked by the user in real-time, by a camera system coupled to the server within the autonomous retail store.

In some embodiments, the method comprises a step 115 of relating information of the items picked by the user to the digital token.

In some embodiments, the method comprises a step 120 of recording and forwarding the information of the items picked by the user in real-time to the server.

In some embodiments, the method comprises a step 125 of displaying the information of the items picked by the user in real-time and other information to the user when the user selects to view the information of the items by clicking the digital token, wherein the digital token is stored in a mobile application.

In some embodiments, the method comprises a step 130 of updating the information of the items picked by the user to the digital token when the user continues to shop in the autonomous retail store.

In some embodiments, the method comprises a step 135 of generating a receipt based on the information of the items checked out by the user after the user exits the autonomous retail store, wherein the receipt comprises items checked out by the user, price of any of the items checked out by the user, and regulatory required information.

In some embodiments, the method comprises a step 140 of displaying the information of the items checked out by the user when the user selects to view the information of the items checked out by the user by clicking the digital token.

In some embodiments, the other information comprises advertisement and promotion of products in the autonomous retail store.

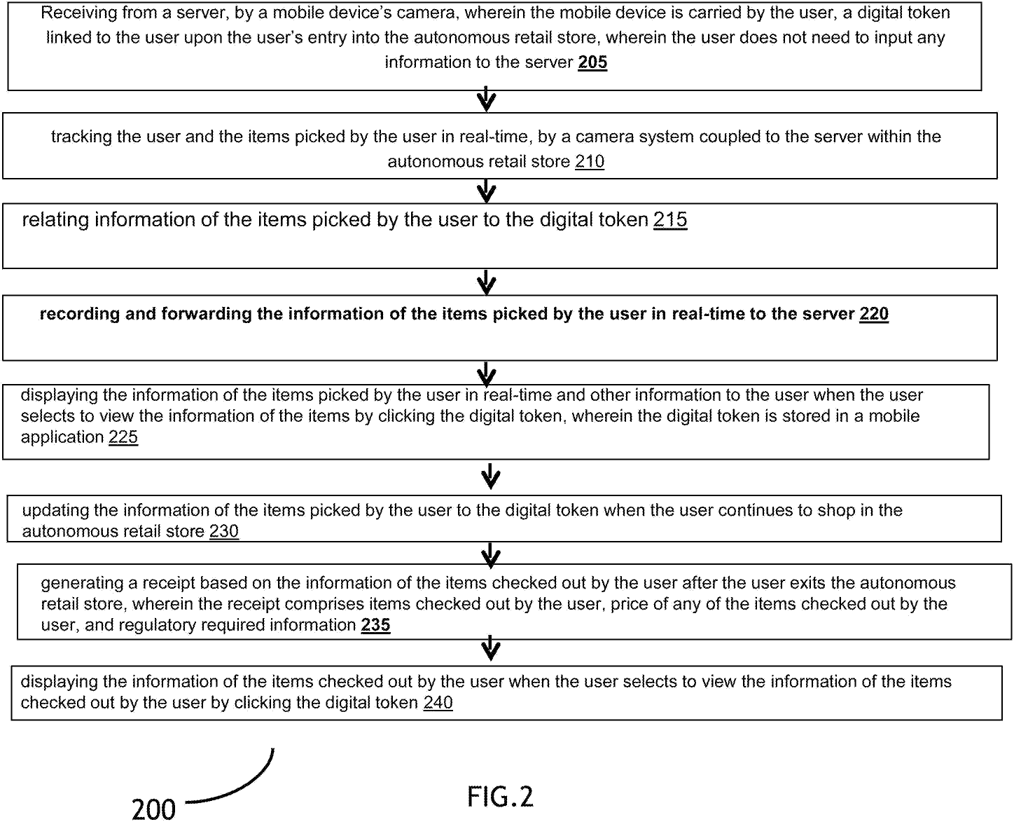

FIG. 2 shows another example of another method 200 of tracking items picked by a user in an autonomous retail store.

In some embodiments, the method comprises a step 205 of receiving, by a mobile device’s camera, a digital token linked to the user upon the user’s entry into the autonomous retail store, wherein the user does not need to input any information to the server.

In some embodiments, the method comprises a step 210 of tracking the user and the items picked by the user in real-time, by a camera system coupled to the server within the autonomous retail store.

In some embodiments, the method comprises a step 215 of relating information of the items picked by the user to the digital token.

In some embodiments, the method comprises a step 220 of recording and forwarding the information of the items picked by the user in real-time to the server.

In some embodiments, the method comprises a step 225 of displaying the information of the items picked by the user in real-time and other information to the user when the user selects to view the information of the items by clicking the digital token, wherein the digital token is stored in a mobile application.

In some embodiments, the method comprises a step 230 of updating the information of the items picked by the user to the digital token when the user continues to shop in the autonomous retail store.

In some embodiments, the method comprises a step 235 of generating a receipt based on the information of the items checked out by the user after the user exits the autonomous retail store, wherein the receipt comprises items checked out by the user, price of any of the items checked out by the user, and regulatory required information.

In some embodiments, the method comprises a step 240 of displaying the information of the items checked out by the user when the user selects to view the information of the items checked out by the user by clicking the digital token.

In some embodiments, the other information comprises advertisement and promotion of products in the autonomous retail store.

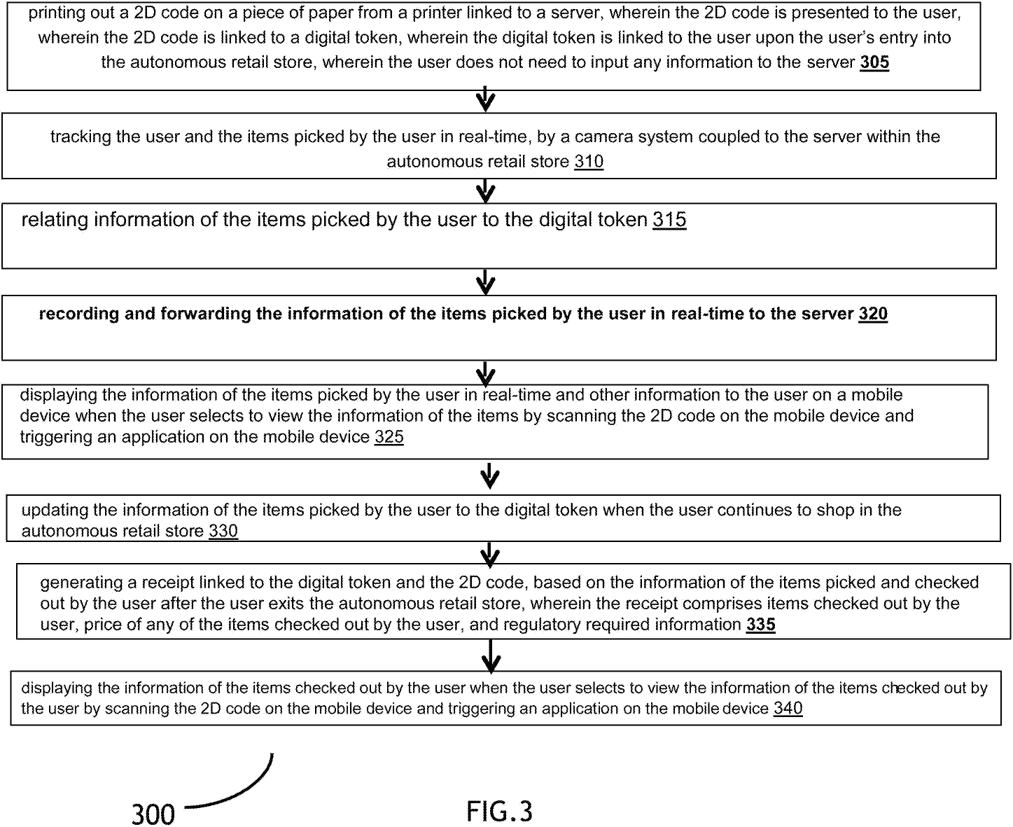

FIG. 3 shows a third example of a third method 300 of tracking items picked by a user in an autonomous retail store.

In some embodiments, the method comprises a step 305 of printing out a 2D code on a piece of paper from a printer linked to a server, wherein the 2D code is presented to the user, wherein the 2D code is linked to a digital token, wherein the digital token is linked to the user upon the user’s entry into the autonomous retail store, wherein the user does not need to input any information to the server.

In some embodiments, the method comprises a step 310 of tracking the user and the items picked by the user in real-time, by a camera system coupled to the server within the autonomous retail store.

In some embodiments, the method 300 comprises a step 315 of relating information of the items picked by the user to the digital token.

In some embodiments, the method comprises a step 320 of recording and forwarding the information of the items picked by the user in real-time to the server.

In some embodiments, the method comprises a step 325 of displaying the information of the items picked by the user in real-time and other information to the user on a mobile device when the user selects to view the information of the items by scanning the 2D code on the mobile device and triggering an application on the mobile device.

In some embodiments, the method comprises a step 330 of updating the information of the items picked by the user to the digital token when the user continues to shop in the autonomous retail store.

In some embodiments, the method comprises a step 335 of generating a receipt linked to the digital token and the 2D code, based on the information of the items picked and checked out by the user after the user exits the autonomous retail store, wherein the receipt comprises items checked out by the user, price of any of the items checked out by the user, and regulatory required information.

In some embodiments, the method comprises a step 340 of displaying the information of the items checked out by the user when the user selects to view the information of the items checked out by the user by scanning the 2D code on the mobile device and triggering an application on the mobile device.

In some embodiments, the other information comprises advertisement and promotion of products in the autonomous retail store.

1. A method of tracking items picked by a user in an autonomous retail store, comprising:
receiving, by a mobile device held by the user via a communications network from a server, a digital token linked to the user upon the user’s entry into the autonomous retail store, wherein the user does not need to input any information to the server;
tracking the user and the items picked by the user in real-time, by a camera system coupled to the server within the autonomous retail store;
relating information of the items picked by the user to the digital token;
recording and forwarding the information of the items picked by the user in real-time to the server;
displaying the information of the items picked by the user in real-time and other information to the user when the user selects to view the information of the items by clicking the digital token, wherein the digital token is stored in a mobile application;
updating the information of the items picked by the user to the digital token when the user continues to shop in the autonomous retail store;
generating a receipt based on the information of the items checked out by the user after the user exits the autonomous retail store, wherein the receipt comprises items checked out by the user, price of any of the items checked out by the user, and regulatory required information; and
displaying the information of the items checked out by the user when the user selects to view the information of the items checked out by the user by clicking the digital token.

2. The method of tracking items picked by a user in an autonomous retail store in claim 1,
wherein the other information comprises advertisement and promotion of products in the autonomous retail store.

3. A method of tracking items picked by a user in an autonomous retail store, comprising:
Receiving from a server, by a mobile device’s camera, wherein the mobile device is carried by the user, a digital token linked to the user upon the user’s entry into the autonomous retail store, wherein the user does not need to input any information to the server;
tracking the user and the items picked by the user in real-time, by a camera system coupled to the server within the autonomous retail store;
relating information of the items picked by the user to the digital token;
recording and forwarding the information of the items picked by the user in real-time to the server;
displaying the information of the items picked by the user in real-time and other information to the user when the user selects to view the information of the items by clicking the digital token, wherein the digital token is stored in a mobile application;
updating the information of the items picked by the user to the digital token when the user continues to shop in the autonomous retail store;
generating a receipt based on the information of the items checked out by the user after the user exits the autonomous retail store, wherein the receipt comprises items checked out by the user, price of any of the items checked out by the user, and regulatory required information; and
displaying the information of the items checked out by the user when the user selects to view the information of the items checked out by the user by clicking the digital token.

4. The method of tracking items picked by a user in an autonomous retail store in claim 3, wherein the other information comprises advertisement and promotion of products in the autonomous retail store.

5. A method of tracking items picked by a user in an autonomous retail store, comprising:
printing out a 2D code on a piece of paper from a printer linked to a server, wherein the 2D code is presented to the user, wherein the 2D code is linked to a digital token, wherein the digital token is linked to the user upon the user’s entry into the autonomous retail store, wherein the user does not need to input any information to the server;
tracking the user and the items picked by the user in real-time, by a camera system coupled to the server within the autonomous retail store;
relating information of the items picked by the user to the digital token;
recording and forwarding the information of the items picked by the user in real-time to the server;
displaying the information of the items picked by the user in real-time and other information to the user on a mobile device when the user selects to view the information of the items by scanning the 2D code on the mobile device and triggering an application on the mobile device;
updating the information of the items picked by the user to the digital token when the user continues to shop in the autonomous retail store;
generating a receipt linked to the digital token and the 2D code, based on the information of the items picked and checked out by the user after the user exits the autonomous retail store, wherein the receipt comprises items checked out by the user, price of any of the items checked out by the user, and regulatory required information; and
displaying the information of the items checked out by the user when the user selects to view the information of the items checked out by the user by scanning the 2D code on the mobile device and triggering an application on the mobile device.

6. The method of tracking items picked by a user in an autonomous retail store in claim 5, wherein the other information comprises advertisement and promotion of products in the autonomous retail store.
